(19) United States
(12) Patent Application Publication
(10) Pub. No.: US 2004/0230558 A1
(43) Pub. Date: Nov. 18, 2004

(54) Information processing apparatus, storage medium, and metadata display method

(76) Inventor: Junzo Tokunaka, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/798,056

(22) Filed: Mar. 11, 2004

(30) Foreign Application Priority Data
Mar. 14, 2003 (JP) 2003-069496

(51) Int. Cl. G06F 7/00

(52) U.S. Cl. 707/1

(57) ABSTRACT

The present invention provides an information processing apparatus, a storage medium, and a metadata display method for directly and easily displaying on the storage medium metadata associated with content data stored in the storage medium. The information processing apparatus handles the storage medium storing content data and the metadata associated with the content data. An information display area is formed on the storage medium. The information processing apparatus has an extracting section for extracting, from the metadata stored in the storage medium, data to be displayed in the information display area and an information display unit for displaying the extracted display data onto the information display area. In this novel configuration, the information processing apparatus can directly and easily display at least a part of the metadata stored in the storage medium onto the surface thereof.

### BACKGROUND OF THE INVENTION

The present invention relates generally to an information processing apparatus, a storage medium, and a metadata display method.

Recently, the use of metadata associated with various content data handled by information processing apparatuses has been increasingly advancing in various fields. Especially, in the fields of the production of video works such as TV programs and video content, the effective use of metadata associated with imaged video materials (or video content data) has been quickly progressing. These metadata associated with video materials include the information representative of such video material attributes as video title, name of person who took video, and date on which video was taken for example. These pieces of information are useful in the identification and organization of the recording media (namely, removable recording media such as optical disks and video tapes) on which video materials are recorded.

Therefore, conventionally, the metadata associated with recorded video materials are handwritten for example on paper labels and these labels are pasted on recording media for their organization. In addition, these handwritten metadata are sometimes entered in a computer to form a database.

In another conventional method for metadata organization, metadata are retrieved from the above-mentioned database to be coded in barcodes which are then attached to recording media or IC memories storing metadata are attached to recording media for their organization (refer to Japanese Patent Laid-open No. 2002-25228).

However, the above-mentioned conventional method of attaching handwritten labels to recording media for their organization takes time and labor and sometimes involves writing errors to make the organization defective. In addition, an attempt for organizing handwritten metadata by putting them into a database requires an additional job of putting them into a computer, which makes the organization complicated and involves data input errors.

On the other hand, the above-mentioned method of organizing metadata by means of barcodes or IC memories separately requires a barcode reader or an IC memory reader for checking the video material metadata recorded to recording media, thereby presenting inconvenience that the content information about recording media cannot be directly visually checked.

If, in order to overcome the above-mentioned inconvenience, the metadata read from a barcode or IC memory database are printed on labels for example and attach them to recording media, they must be detached every time the metadata are updated and new labels must be attached, thereby requiring time and labor.

### SUMMARY OF THE INVENTION

It is therefore an object of the present invention to provide a novel and improved information processing apparatus, storage medium, and metadata display method that are capable of directly and easily display the metadata associated with content data recorded to recording media and easily update this display of metadata.

In carrying out the invention and according to one aspect thereof, there is provided an information processing apparatus for handling a storage medium storing content data and metadata associated therewith. This information processing apparatus with an information display area formed on a surface of the storage medium, has an extracting section for extracting, from the metadata stored on the storage medium, display data to be displayed in the information display area and an information display unit for displaying the extracted display data onto the information display area.

In the above-mentioned novel configuration, the extracting section can read metadata from a loaded storage medium to extract at least a part of metadata as data to be displayed. The information display unit can display the display data extracted by the extracting section onto the information display area by printing for example. As a result, at least a part of the metadata stored in the storage medium concerned is directly shown on the information display area. Thus, the information processing apparatus can directly and easily display the metadata associated with the content data stored in the storage medium concerned onto the surface thereof. It should be noted that the extracting section can extract, as display data, all or part of the metadata stored in the storage medium.

The above-mentioned information display area may be rewritable. Consequently, when the metadata stored in the storage medium are updated, the contents of the information display area can be rewritten accordingly.

The above-mentioned information display area may be exchangeable with another information display area. Consequently, the information display area can be exchanged with new one after the expiration of its service life or damage, thereby ensuring the continuation of the metadata display on the surface of the storage medium.

The above-mentioned information display area may be constituted by a rewrite sheet. Consequently, metadata can be displayed and rewritten in a suitable manner. In addition, the above-mentioned rewrite sheet may be a thermo rewrite sheet. Consequently, the displayed metadata can be rewritten suitably and easily.

The above-mentioned information display unit may display, in the information display area, the display data by coding at least a part thereof. Consequently, mechanically readable barcode information can also be displayed on the surface of the recording medium.

The above-mentioned information processing apparatus also may have a metadata editing section for editing the metadata in accordance with a processing result of the content data. The extracting section may extract the display data also from the edited metadata. Consequently, the metadata newly created in the information processing apparatus or the metadata obtained by updating the metadata stored in the storage medium can also be displayed on the surface of the storage medium.

The above-mentioned content data may include at least video content data and the information display unit displays, in the information display area, thumbnail image data extracted from the video content data on the basis of the metadata. Consequently, a thumbnail image, which is a typical still-picture image in the video content data stored in the storage medium can be displayed on the surface thereof.

The above-mentioned extracting section may be configured so as to extract display data as instructed by the user. Consequently, user-specified metadata can be displayed on the surface of the storage medium.

The above-mentioned extracting section may be configured so as to automatically extract display data under preset extracting conditions. Consequently, the metadata recorded in the storage medium can be automatically displayed on the surface of the storage area.

In carrying out the invention and according to another aspect thereof, there is provided a storage medium which is accessed for reading and writing by an information processing apparatus. This storage medium stores at least content data and metadata associated therewith and is formed with an information display area on a surface thereof, display data extracted from the metadata being displayed in the information display area by the information processing apparatus.

In the above-mentioned novel configuration, metadata stored in a recording medium are read by the information processing apparatus, and at least a part of the metadata is extracted as data to be displayed. Further, the extracted display data are displayed by the information processing apparatus onto the information display area on the storage medium by printing for example. Consequently, the storage medium, handled by the information processing apparatus, can display the metadata associated with the content data stored in itself onto the surface thereof.

The above-mentioned information display area may be rewritable. Consequently, when the metadata stored in the storage medium are updated, the contents displayed in the information display area can be rewritten accordingly.

The above-mentioned information display area may be exchangeable with another information display area. Consequently, the information display area can be exchanged after the expiration of its service life or damage, thereby ensuring the continuation of metadata display on the surface of the storage medium.

The above-mentioned information display area may be constituted by a rewrite sheet. Consequently, metadata can be displayed and rewritten in a suitable manner. The above-mentioned rewrite sheet may be a thermo rewrite sheet. Consequently, the displayed metadata can be suitably and easily rewritten.

In carrying out the invention and according to still another aspect thereof, there is provided a metadata display method for displaying metadata on a surface of a storage medium storing the content data and metadata associated therewith. An information display area is formed on the surface of the storage medium. The above-mentioned metadata display method comprises the steps of extracting, by the information processing apparatus handling the storage medium, from the metadata stored on the storage medium, display data to be displayed in the information display area, and displaying the extracted display data onto the information display area.

In this novel configuration, the information processing apparatus reads metadata recorded to a loaded storage medium, extracts at least a part of the metadata as the data to be displayed, and displays the extracted display data onto the information display area by printing for example. Consequently, the metadata associated with the content data stored in the storage medium concerned can be directly and easily shown on the surface of that storage medium. It should be noted that the display data are all or part of the metadata stored in the storage medium.

The above-mentioned information display area may be rewritable. The above-mentioned information display area may be exchangeable with another information display area. The above-mentioned information display area may be constituted by a rewrite sheet. At least a part of the extracted display data may be coded to be displayed in the information display area.

The above-mentioned display data may be extracted also from the metadata edited by the information processing apparatus.

The above-mentioned content data may include at least video content data and thumbnail image data extracted from the video content data on the basis of the metadata are displayed in the information display area.

### BRIEF DESCRIPTION OF THE DRAWINGS

These and other objects of the invention will be seen by reference to the description, taken in connection with the accompanying drawing, in which:

FIG. 1 is a block diagram illustrating an approximate configuration of a video program production assistance system practiced as a first embodiment of the invention;

FIG. 2 is a perspective view illustrating an optical disk associated with the first embodiment;

FIG. 3 is a perspective view illustrating the optical disk associated with the first embodiment with a metadata display sheet loaded thereon;

FIG. 4 is a block diagram illustrating an approximate configuration of a recording/reproducing apparatus associated with the first embodiment;

FIG. 5 is a block diagram illustrating an approximate configuration of a metadata processing unit associated with the first embodiment;

FIG. 6 is a diagram illustrating manual extraction processing associated with the first embodiment;

FIG. 7 is a diagram illustrating layout adjustment processing associated with the first embodiment;

FIG. 8 is a diagram illustrating an example of metadata printed on a metadata display sheet by a printer associated with the first embodiment;

FIG. 9 is a diagram illustrating another example of metadata printed on a metadata display sheet by the printer associated with the first embodiment;

FIG. 10 is a flowchart describing a metadata automatic display method associated with the first embodiment;

FIG. 11 is a flowchart describing a metadata semi-automatic display method associated with the first embodiment;

FIGS. 12A and 12B are diagrams illustrating a configuration of an optical disk associated with a variation to the first embodiment; and

FIGS. 13A, 13B, and 13C are perspective views illustrating a video tape, a memory card, and a photographic film respectively which are recording media associated with the variation to the first embodiment.

### DETAILED DESCRIPTION OF PREFERRED EMBODIMENTS

This invention will be described in further detail by way of example with reference to the accompanying drawings. It should be noted that, throughout the specification hereof and drawings attached thereto, components having substantially the same functional configurations are denoted by the same reference numerals and their description will be skipped for the brevity of description.

First Embodiment:

The following describes an information processing apparatus, a recording medium, and a metadata display method which are associated with the first embodiment of the invention. In what follows, an example used in which the information processing apparatus according to this first embodiment is configured as a recording/reproducing apparatus for recording/reproducing video content data for example and the recording medium according to this embodiment is configured as an optical disk which can be accessed for reading or writing by the above-mentioned recording/reproducing apparatus; however, this example is illustrative only and therefore various other examples are practicable with the invention.

The recording/reproducing apparatus according to the first embodiment is characterized by that metadata recorded to an optical disk along with video content data are read, which are printed for display in an information display area formed on a surface of the optical disk. In what follows, an example of a system environment in which the above-mentioned recording/reproducing apparatus is used will be described in an overview manner, followed by a detailed description of the configurations of the recording medium and the recording/reproducing apparatus for realizing the above-mentioned feature, followed by a description of a metadata display method which is based on these recording medium and recording/reproducing apparatus.

(1) System Environment

First, a video program production assistance system according to the first embodiment will be outlined below.

The video program production assistance system is installed in television broadcasting stations, video content and movie productions, and other sites and used to produce video programs which are video works such as TV programs, video content, and movies. In this video program production assistance system, various kinds of metadata and video content data can be transferred between the terminal apparatuses constituting this system via storage media such as optical disks and memory cards.

The video content data are video data and or audio data which constitute each video program; for example, content data such as moving-picture data including TV programs and movies. It is to be noted that the video content data may include, in addition to the above-described data, still picture data such as pictures and photographs and audio data such as radio programs.

Metadata are higher data associated with above-mentioned video content data for example and function as the index information for example indicative of the attribute and outline of the video content data. The metadata include all such index information required for the search, editing, and management of storage media as UMID, organization table metadata, characters, graphics, numerals, barcodes, and representative still pictures.

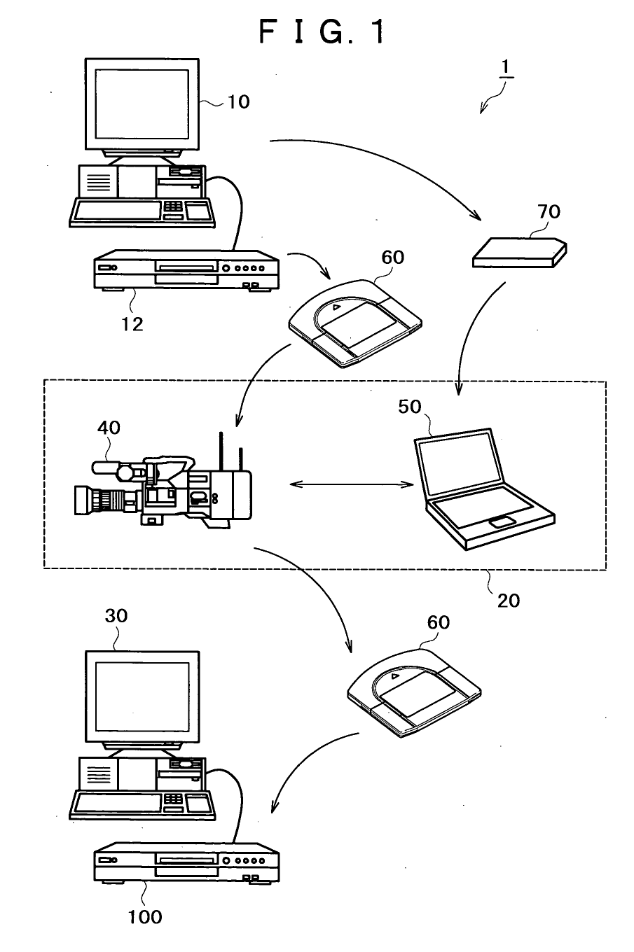

The following describes a configuration of the video program production assistance system according to the present embodiment with reference to FIG. 1. FIG. 1 is a block diagram illustrating an approximate configuration of the video program production assistance system.

As shown in FIG. 1, a video program production assistance system 1 according to the present embodiment is mainly composed of a planning terminal apparatus 10, a material gathering apparatus 20 composed of an imaging apparatus 40 and a field PC/PDA (hereafter referred to as a field PC) 50 for example, and an editing terminal apparatus 30 having a recording/reproducing apparatus 100.

The planning terminal apparatus 10, the material gathering terminal apparatus 20, and the editing terminal apparatus 30 are terminal apparatuses which are used by a planning and organization department, a material gathering department, and an editing department respectively for example of a video program production organization.

The planning terminal apparatus 10 is configured by an information processing apparatus such as a personal computer and its peripheral equipment and installed in a planning and organization department. This planning and organization department collectively controls the entire production of video programs, creates scenarios by planning and conceptualizing video programs to be produced and, at the same time, gives production job specifications to the other departments such as the material gathering department and the editing department. On the basis of the input made by the stuff of the planning and organization department, the planning terminal apparatus 10 can create the metadata associated with the instructions and specifications about the contents of production of video programs (the metadata hereinafter referred to as production specification metadata).

The production specification metadata include the ID and title of an entire video program, the ID and title of each of material gatherings and scenes constituting the video program, the appointment of reporters and camera operators, and the specification of the site, date, and contents of material gathering, for example.

The planning terminal apparatus 10 has a recording/reproducing apparatus 12 for writing or reading various data such as the above-mentioned production specification metadata to or from storage media such as an optical disk 60 and a memory card 70. Therefore, the planning terminal apparatus 10 can provide the production specification metadata created as described above to the material gathering terminal apparatus 20 and the editing terminal apparatus 30 via the optical disk 60 or the memory card 70, for example. Thus, the provision by the planning terminal apparatus 10 of the production specification metadata to the material gathering terminal apparatus 20 for example allows the planning and organization department to inform the material gathering department for example of a scene to be covered and recorded along a scenario and the specific contents of these coverage and recording. It should be noted that the above-mentioned provision of production specification metadata for example may be transmitted via a network (not shown) which interconnect the planning terminal apparatus 10, the material gathering terminal apparatus 20 and the editing terminal apparatus 30.

The material gathering terminal apparatus 20 is a group of terminals for use by the material gathering department and is configured by the imaging apparatus 40 and the field PC 50 for example. The material gathering department actually gathers material at production site as instructed by the above-mentioned planning and organization department for example, thereby recording the scenes constituting each video program and gathering information about the recording situations.

The imaging apparatus 40 is a video camera such as a camcorder which is used for gathering materials about news programs for broadcasting and recording sport games for example and video content such as movies.

The imaging apparatus 40 can display the production specification metadata obtained from the planning terminal apparatus 10 onto a predetermined display unit (not shown) to have the material gathering staff such as camera operator recognize the contents to be recorded and gathered.

Also the imaging apparatus 40, on the basis of the above-mentioned production specification metadata, can pick up each of the scenes constituting a video program and record the video content data corresponding to each pick-up scene to the optical disk 60. The imaging processing executed by use of the imaging apparatus 40 progresses by repeating takes a plurality number of times for example. For example, the imaging apparatus 40 executes one or more takes for a certain scene and then one or more takes for another scene. It should be noted that term “take” as used herein denotes one continuous process of recording by the imaging apparatus 40 from its start to end. Therefore, the imaging apparatus 40 can record the above-mentioned video content data for each take.

In addition, the imaging apparatus 40 can generate the recording condition metadata associated with the recording condition information at the time of recording, the electronic mark metadata representative of positions of scenes which feature in video content data, and the content identification metadata for identifying video content data, for example.

The recording condition metadata include recording time, the latitude/longitude information of recording location, the device number of the imaging apparatus 40, and the setting information of the imaging apparatus 40 (aperture, filter type, white balance, gain, DCC, and so on), for example. The contents of update and editing of the production specification metadata include the change to the names of camera operator or reporter who actually carried out material gathering, the addition of actual recording, the addition of correlation information between the video content data and the scenario of actually recorded takes, the addition of take numbers, and the addition of OK/NG information of each take, for example.

The electronic mark metadata are representative of the indexes of the still pictures (thumbnail images) which are typical in the video content data of one take and the feature scenes in the video, for example. These electronic mark metadata include a recording start mark indicative of the position at which recording started, a recording end mark indicative of the position at which recording ended, a shot mark indicative of the position of a video scene of interest specified by camera operator for example as a good, bad shot or the like during recording, a flash mark indicative of the position at which many flashes from cameras of press corps were detected in a video scene, a recording condition change mark indicative of the position the recording condition was changed by the imaging apparatus 40, and a mega-volume mark indicative of the position at which audio (voice) output level exceeded limit value, for example. These electronic mark data are corded as time code information for example.

The content identification metadata include UMID, take number, video content data file name, correlation data between video content data of actually recorded take and planned scenario (production specification metadata), and OK/NG information of each take, for example.

On the other hand, the field PC 50 is configured by a portable computer such as a note-size personal computer or a PDA (Personal Digital Assistant) and its peripheral equipment, for example. The field PC 50 can be connected to the imaging apparatus 40 by one of various types of wired or wireless communication lines to share metadata and video content data with the imaging apparatus 40, for example.

The field PC 50 can get various kinds of metadata from other equipment such as the planning terminal apparatus 10 and imaging apparatus 40 via recording media such as the memory card 70 for example. The field PC 50 displays the obtained production specification metadata for example onto a predetermined display unit, thereby allowing the staff of the material gathering department to recognize the contents of the production specification metadata. Also, on the basis of the input by the staff of the material gathering department for example, the field PC 50 can generate material gathering situation metadata composed of material gathering memo information associated with material gathering situation and update and edit the production specification metadata or the recording condition metadata obtained from the planning terminal apparatus 10 or the imaging apparatus 40, for example.

To be more specific, the material gathering situation metadata include the memo information about the material gathering situation inputted by the staff of the material gathering department for example; more specifically, the material gathering situation metadata include the messages, notabilia, and proposals made by the material gathering staff at the time of recording, the characteristics and impressions of recorded scenes, the items which took place in recording job, and the supplementary explanations associated with video content data, for example. The contents of the update and editing of production specification metadata include the updating of the names of camera operator and reporter who carried out actual material gathering and the addition or updating of actual recording date and place.

The metadata thus created or edited by the field PC 50 are supplied to the imaging apparatus 40. The imaging apparatus 40 synchronize the metadata received from the field PC 50 with the metadata generated by itself or received from the planning terminal apparatus. Further, the imaging apparatus 40 records the metadata generated and edited at the stage of material gathering to the optical disk 60 as related with video content data. The optical disk 60 on which video content data and the metadata associated therewith are recorded by the imaging apparatus 40 is supplied to the editing terminal apparatus 30.

The editing terminal apparatus 30 is configured by an information processing apparatus such as a personal computer and its peripheral equipment for example and installed in the editing department. On the basis of the production specifications and scenario given from the planning and organization department and the material gathering situation obtained at the stage of material gathering and the recording condition for example, the editing department edits the video content data recorded by the imaging apparatus 40 to complete a video program.

The editing terminal apparatus 30 has a recording/reproducing apparatus 100 which can record and reproduce the above-mentioned various metadata and video content data with the optical disk 60 for example. Therefore, the editing terminal apparatus 30 can reproduce the video content data from the optical disk 60, edits the video content data, and records them to the optical disk 60 again.

To be more specific, the editing terminal apparatus 30 can get video content data from the imaging apparatus 40 via the optical disk 60, for example. Also, the editing terminal apparatus 30 can reproduce the video content data from the optical disk 60 for example singly for each take or continuously in a preferable sequence and display the reproduced data. Further, the editing terminal apparatus 30 can assist the editing the these video content data, for example. This edit processing is composed of rough edit processing and main edit processing.

In the rough edit processing, the video content data to be used by the main editing are collected from a plurality of video content data recorded for each take, the necessary video part is selected (or logged) from the collected video content data, and the edit start position (or the in-point) and the edit end position (or the out-point) corresponding to the logged video part are set by a time code for example, thereby extracting (or ingesting) a necessary part from the video content data, for example. In the main edit processing, the plurality of video content data after the rough editing described above are picked up and connected with each other and final picture quality adjustment for example is performed on the connected video content data, thereby creating complete package data to be broadcast in a program, for example.

Further, the editing terminal apparatus 30 can read the above-mentioned various metadata from the optical disk 60 which are recorded thereto as related with the above-mentioned content data, by use of the recording/reproducing apparatus 100. In addition, the editing terminal apparatus 30 can display the read metadata onto a monitor for example to show to the editing staff the attribute and features of the video content data to be edited. Moreover, the editing terminal apparatus 30 can edit the above-mentioned metadata in accordance with the above-mentioned edit processing and generate edit result metadata composed of the above-mentioned in-point, out-point and the like by itself.

Still further, the recording/reproducing apparatus 100 of the editing terminal apparatus 30 has a characteristic capability. Namely, the recording/reproducing apparatus 100 can read metadata from the optical disk 60, extract the data therefrom for display, and print for display the data to be displayed onto an information display area formed on the surface of the optical disk 60. This characteristic capability of the recording/reproducing apparatus 100 can display the metadata concerned on the surface of the optical disk 60 in a manner recognizable and understandable by the user. The details of the recording/reproducing apparatus 100 will be described later.

(2) Storage Media

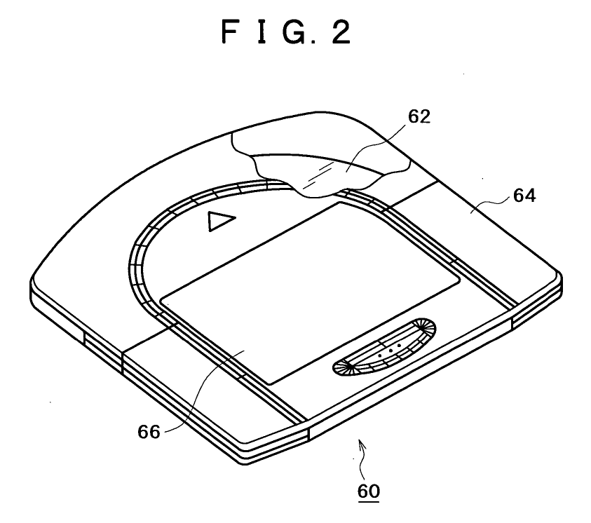

The following describes in detail the optical disk 60 which is a typical example of storage media associated with the present embodiment with reference to FIG. 2. FIG. 2 is a perspective view of the optical disk 60.

As shown in FIG. 2, the optical disk 60 is a removable recording medium which can be read or written on the imaging apparatus 40 and the recording/reproducing apparatus 100 for example. In the present embodiment, the optical disk 60 is configured, but not exclusively, as a mass storage, next-generation optical disk capable of storing mass data (for example, several hundred gigabytes); for example, various other types of optical disk such as CD-RW, CD-R, DVD-RW, DVD-R, DVD-RAM, MO, or PD may also used as the optical disk 60.

The optical disk 60 configured as described above is loaded on the imaging apparatus 40 and the above-mentioned various kinds of metadata associated with video content data are recorded to the optical disk 60 along with these video content data. On the other hand, the optical disk 60 is loaded on the recording/reproducing apparatus 100 of the editing terminal apparatus 30 and the video content data concerned and their metadata are read from time to time as required from the optical disk 60.

As shown in FIG. 2, the optical disk 60 is composed of a disk body 62 which is approximately disk-shaped for storing various kinds of information and cartridge 64 which encloses the disk body 62 for protection, and a metadata display sheet 66 attached to the surface of the cartridge 64.

The metadata display sheet 66 is configured as the information display area which is one characteristic of the present embodiment. The metadata display sheet 66 functions as the metadata display label for example when metadata are printed on its surface by a printer or the like of the recording/reproducing apparatus 100 to be described later.

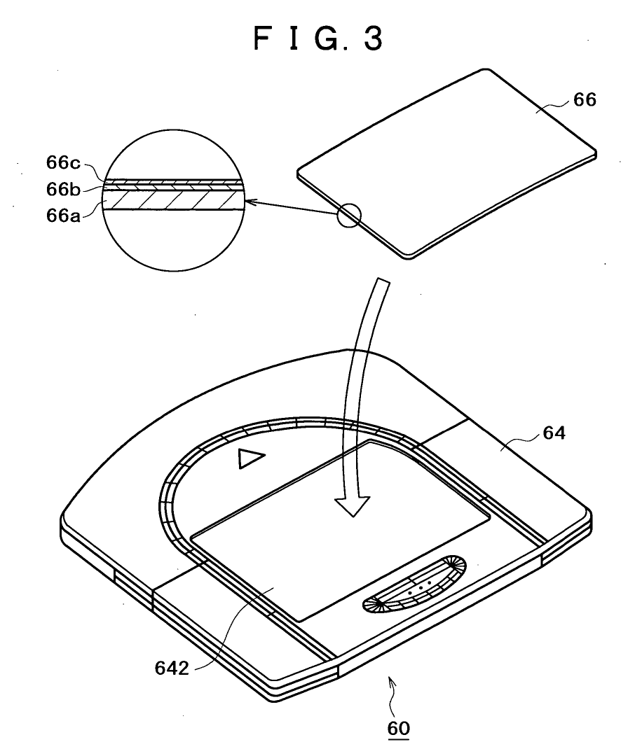

As shown in FIG. 3, the metadata display sheet 66 is attached, with an adhesive for example, to a mounting space 642 which is approximately rectangular in shape and formed in approximately center of the cartridge 64 in a depressed manner, for example. The mounting space 642 may also be formed such that its shape is suited for the shape of the metadata display sheet 66 and depressed by a depth corresponding to the thickness of the metadata display sheet 66. The position at which the mounting space 642 is formed may also be approximately the same position of the space in which a handwritten paper label is attached on a conventional optical disk with cartridge.

The metadata display sheet 66 described above is made of a thermo rewrite sheet for example. The thermo rewrite sheet is a color-developing rewrite sheet (or film) based on thermo-sensitive color-developing material which can be colorized or decolorized, for example. This material is typically used for credit cards, reward cards, and member cards.

To be more specific, the thermo rewrite sheet is made up of a base layer 66a based on PET, a write layer 66b which includes leuco-type or transparent-opaque thermo-sensitive color-developing material, and a protection layer 66c, from bottom to top, and the like as shown in FIG. 3. The thickness of this thermo rewrite sheet depends on the thickness of the base layer 66a; for example, the thickness of the thermo rewrite sheet is 100 to 500 microns. The thermo rewrite sheet described above can colorize or decolorize clear and fine characters, graphics, and images in accordance with the heating by printer for example. The color development of this thermo rewrite sheet may also be single-colorizing such as blue on white, red on white, and black on white or opaque on silver or multi-colorizing. In addition, the thermo rewrite sheet can rewrite, more than several hundred times, the contents displayed by the above-mentioned color development, for example.

Therefore, the metadata display sheet 66 configured by the thermo rewrite sheet and the like is printed on its front surface with metadata (data to be displayed) by a printer to be described later, thereby displaying the metadata in an externally visually recognizable manner. Due to its above-mentioned properties of the rewrite sheet, the metadata display sheet 66 can quickly and easily rewrite the contents of metadata to be displayed.

Further, in order to reduce the amount of data to be rewritten, a form frame, a pattern, and/or a header of metadata which need not be rewritten may be printed on the base layer 66a for example in advance. This always displays the data which need not be rewritten onto the metadata display sheet 66 regardless of the printing by the printer. Consequently, only the metadata which may be updated from time to time are printed for the first time or rewritten by the printer, thereby enhancing the printing efficiency of the printer and increasing the service life of the metadata display sheet 66.

Moreover, the metadata display sheet 66 can be replaced with ease, for example. Namely, when the service life of the metadata display sheet 66 has come to an end after repeated rewrite operations or damage, the metadata display sheet 66 can be easily detached from the optical disk 60 to be replaced with new one.

(3) Information Processing Apparatus

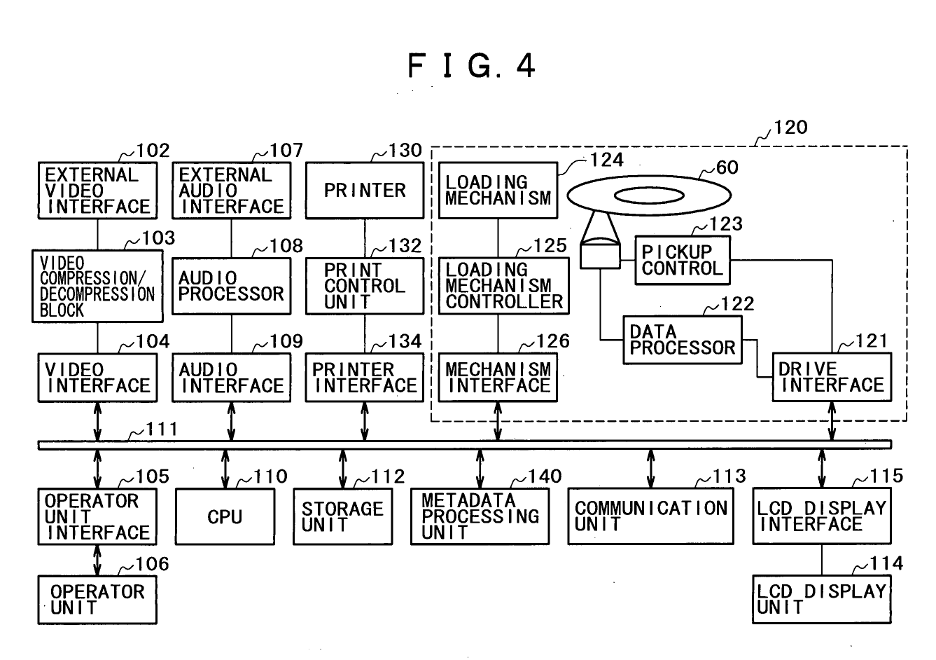

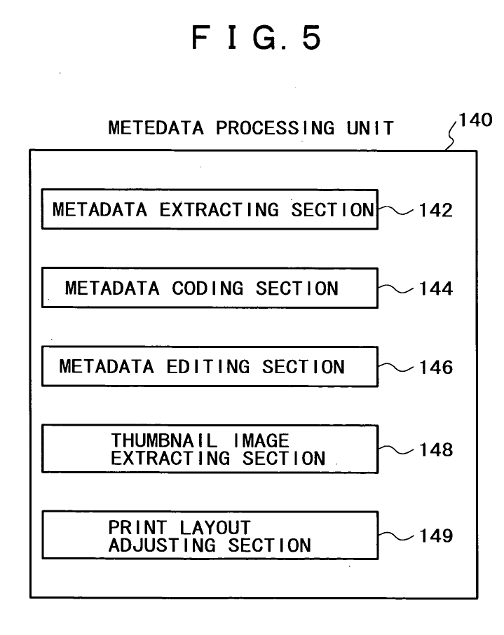

The following describes the recording/reproducing apparatus 100 which is one example of the information processing apparatus according to the present embodiment with reference to FIG. 5. FIG. 4 is a block diagram approximately illustrating a configuration of the recording/reproducing apparatus 100 according to the present embodiment.

The recording/reproducing apparatus 100 is a disk apparatus for reading and writing video content data and their metadata on the optical disk 60, for example. To be more specific, the recording/reproducing apparatus 100 reproduces video content data from the optical disk 60, displays the video content data onto the monitor of the editing terminal apparatus 30, and records the video content data edited by the editing terminal apparatus 30 to the optical disk 60 from which the video content were read or to another optical disk 60. In addition, the recording/reproducing apparatus 100 reads various metadata associated with the video content data recorded to the optical disk 60, extracts the data to be displayed from these metadata, and prints the extracted metadata to the metadata display sheet 66 attached on the optical disk 60.

The following describes each of the components of the recording/reproducing apparatus 100.

As shown in FIG. 4, the recording/reproducing apparatus 100 is composed of an external video interface 102, a video compression/decompression unit 103, a video interface 104, a data bus 111, an operator unit interface 105, an operator unit 106, an external audio interface 107, an audio processor 108, an audio interface 109, a CPU 110, a storage unit 112, a communication unit 113, an LCD display unit 114, an LCD display interface 115, a recording/reproducing unit 120, a printer 130, a print control unit 132, a printer interface 134, and a metadata processing unit 140.

The external video interface 102 functions as the medium for transferring video data among video content data to the outside (for example, the editing terminal apparatus 30) or as the medium for transferring video data supplied from the outside to the video compression/decompression unit 103.

The video compression/decompression unit 103 compresses (or encodes) or decompresses (or decodes) video data on the basis of motion JPEG, MPEG1, MPEG2-TS, or MPEG2-PS for example. The video interface 104 functions as the medium for transferring compressed or decompressed video data between the data bus 111 and the video compression/decompression unit 103.

The operator unit 106 provides operation means such as button, lever, dial, keyboard, and mouse. Through the operator unit 106, editing department staff issues instructions to the recording/reproducing apparatus 100 to execute various processing operations such as video content data reproduction/recording and metadata extraction, new creation, editing, layout adjustment, and printing for example. The operator unit interface 105 functions as the medium for transferring operation instruction signals generated by the operator unit 106 to the data bus 111.

The external audio interface 107 functions as the medium for transferring the audio data among video content data to the outside (for example, the editing terminal apparatus 30) or as the medium for transferring the audio data received from the outside to the audio processor 108.

The audio processor 108 executes A/D conversion and audio adjustment of audio data for example and compresses the audio data as required. The audio interface 109 functions as the medium for transferring the above-mentioned audio data between the data bus 111 and the audio processor 108.

The CPU 110 is a controller constituted by a central processing unit for example and can control the processing and instructions of the components of the recording/reproducing apparatus 100. For example, the CPU 110 starts various programs stored in the storage unit 112 and controls the operations of these programs.

The storage unit 112 is a storage device capable of temporarily recording or storing data such as metadata and video content data and programs. The storage unit 112 is constituted by a RAM (Random Access Memory), a ROM (Read Only Memory), or a hard disk, for example.

The communication unit 113 transmits and receives the above-mentioned various metadata with the editing terminal apparatus 30 for example.

The LCD display unit 114 provides display means such as a liquid crystal display device and displays processing situations of reproduction processing, recording processing, rewind processing, and fast forward processing for example and time codes and the above-mentioned metadata. The LCD display interface 115 functions as the medium for transferring various data to be displayed from the data bus 111 to the LCD display unit 114.

The recording/reproducing unit 120 reproduces the video content data from the optical disk 60 and reads metadata therefrom, for example. In addition, the recording/reproducing unit 120 records edited video content data and the metadata edited along with the editing of video content data to the optical disk 60.

The recording/reproducing unit 120 is composed of a drive interface 121, a data processor 122 for converting the data format of video content data and metadata into a data format suitable for recording/reproducing these data on the optical disk 60, a pickup control 123 for controlling a laser generator/receiving section (not shown) for reading/writing video content data and metadata on the optical disk 60, a loading mechanism 124 for loading/unloading the optical disk 60, a loading mechanism controller 125 for controlling the loading mechanism 124, and a mechanism interface 126 for passing control signals between the loading mechanism controller 125 and the data bus 111, for example.

The printer 130 is configured as an information display unit associated with the present embodiment. For example, the printer 130 is constituted by a thermo-sensitive writer apparatus compliant with the above-mentioned thermo rewrite sheet and prints data to be displayed which are the metadata extracted by the metadata processing unit 140 to be described later onto the metadata display sheet 66 attached on the optical disk 60.

To be more specific, the printer 130, by relatively moving its print head (not shown) and the metadata display sheet 66 in a proper manner, partially heats or cools the metadata display sheet 66 by use of this print head. This causes the thermo-sensitive colorizing material in the thermo rewrite sheet forming the metadata display sheet 66 to colorize (namely, to combine dye with developer) or decolorize (namely, separate dye from developer), resulting in the proper displaying of the above-mentioned data to be displayed onto the metadata display sheet 66.

The execution of print processing by the printer 130 may be set to any desired timing, such as the timing immediately after the loading of the optical disk 60, the timing specified by editing department staff, or the timing immediately before the loading of the optical disk 60.

By repeating the above-mentioned decolorization and print processing, the printer 130 can rewrite, two or more times, the display data on the optical disk 60. The timing of this rewrite processing may also be set as desired as with the above-mentioned print processing timing.

The print control unit 132 controls the operations of the printer 130 as instructed by the CPU 110. For example, the print control unit 132 reads the display data to be printed, holds the display data in a buffer, and outputs the display data from the buffer to the printer 130 in a properly timed relation. The printer interface 134 functions as the medium for transferring the above-mentioned display data and control signals from the data bus 111 to the print control unit 132.

The metadata processing unit 140 executes various processing operations associated with the metadata which are handled in the recording/reproducing apparatus 100. The following describes in detail the configuration of the metadata processing unit 140 with reference to FIG. 5. FIG. 5 is a block diagram approximately illustrating a configuration of the metadata processing unit 140 according to the present embodiment.

As shown in FIG. 5, the metadata processing unit 140 has a metadata extracting section 142, a metadata coding section 144, a metadata editing section 146, a thumbnail image extracting section 148, and a print layout adjusting section 149.

The metadata extracting section 142, configured as an extracting section associated with the present embodiment, searches for, reads, and extracts the metadata recorded to the optical disk 60, automatically or in response to user instruction.

To be more specific, when the optical disk 60 is loaded on the recording/reproducing apparatus 100 for example, the metadata extracting section 142 starts the recording/reproducing unit 120 to automatically search the storage area in the optical disk 60 for metadata and their storage locations. Also, the metadata extracting section 142 can read the detected metadata partially or entirely.

Further, the metadata extracting section 142 can display a part or all of the retrieved metadata onto the LCD display unit 114 and/or the monitor of the editing terminal apparatus 30. In the execution of this display operation, the retrieved metadata may be manipulated, selected, classified, or adjusted in layout for example as required such that the contents of the metadata can be easily browsed by editing department staff. To be more specific, the metadata extracting section 142 can control the display of metadata such that only the title and ID of a video program among the metadata recorded to the optical disk 60 are displayed in a list form.

In addition, the metadata extracting section 142 can extract, from among the metadata recorded to the optical disk 60 for example, the metadata to be displayed on the metadata display sheet 66. This extraction processing may be executed automatically by the metadata extracting section 142 in accordance with an extraction condition preset by editing department staff, for example. Alternatively, this extraction processing may be executed manually in accordance with a selective instruction by the staff every time metadata are read from the optical disk 60.

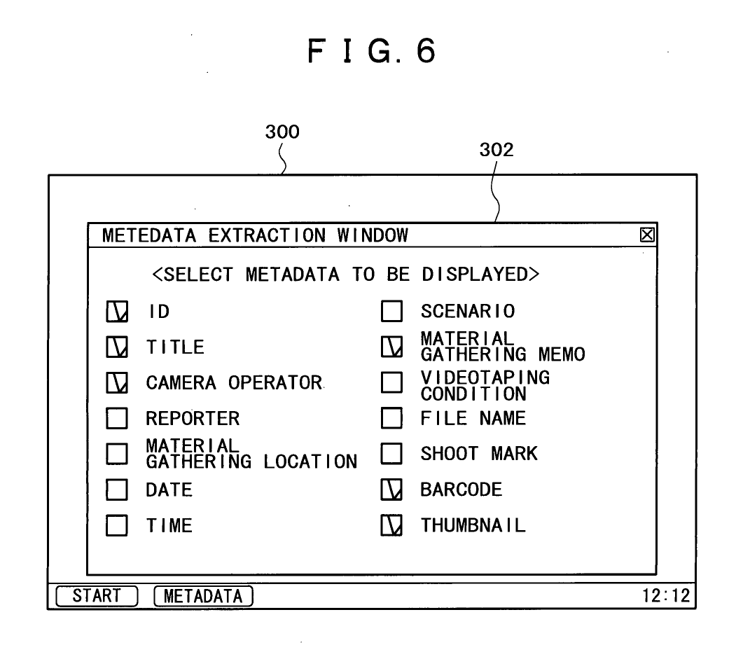

The following describes in detail the above-mentioned manual extraction processing with reference to FIG. 6. FIG. 6 illustrates the manual extraction processing associated with the present embodiment.

When manual extraction processing is specified by the staff for example, the metadata extracting section 142 generates a metadata extraction window 302 on a monitor 300 of the editing terminal apparatus 30 for example and displays the types of selectable metadata in the form of a list in this extraction window 302. By browsing the displayed list, the staff can select, from among a plurality of kinds of metadata, those metadata to be displayed on the metadata display sheet 66 (namely, the display data) in the form of a check list for example. In the example shown in FIG. 6, metadata associated with “ID”, “Title”, “Camera Operator”, “Material Gathering Memo”, “Barcode”, and “Thumbnail” are selected. By this selection, the metadata to be displayed are determined.

The metadata extracting section 142 extracts, as display data, the metadata manually selected as described above and the metadata automatically selected on the basis of the above-mentioned preset extraction conditions. It should be noted that the source of the extraction of display data is not only the metadata recorded to the optical disk 60, but also the metadata edited by the metadata editing section 146 to be described later or the metadata supplied from the outside through another storage media (such as the memory card 7) for example.

The metadata coding section 144 can code at least a part of display data extracted as described above into a barcode form for example. The display data to be coded include all of the above-mentioned metadata; especially, the above-mentioned production specification metadata (for example, video program ID, material gathering ID) and the content identification metadata (for example, UMID, file name of video content data) or the like may be preferably coded.

The metadata editing section 146 can edit metadata in accordance with the contents of the editing processing executed on video content data by the editing terminal apparatus 30 as described above, for example. The metadata editing section 146 can newly create edit result metadata composed of the above-mentioned in-point and out-point on the basis of the rough editing of video content data, for example. Also, by selecting, combining, and overwriting existing metadata for example, the metadata editing section 146 can update the metadata. The metadata thus edited by the metadata editing section 146 may be recorded to the optical disk 60 or stored in the storage unit 112, for example.

The thumbnail image extracting section 148 extracts thumbnail image data from video content data on the basis of the metadata representative of positions (for example, time codes) of typical still images in the video content data. Image data as they are, these thumbnail image data are metadata that are useful in helping understand visually and easily the overview of the video content data recorded to the optical disk 60. Therefore, the metadata extracting section 142 also extracts these thumbnail image data as the above-mentioned display data, for example.

The print layout adjusting section 149 adjusts the layout of the display data printed on the metadata display sheet 66.

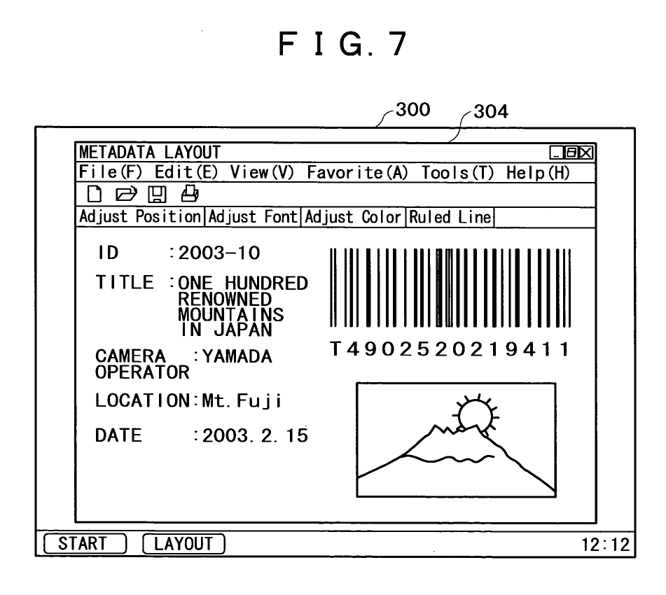

The following describes in detail the layout adjustment processing with reference to FIG. 7. FIG. 7 illustrates the layout adjustment processing according to the present embodiment.

As shown in FIG. 7, the print layout adjusting section 149 generates a print layout adjusting window 304 on the monitor 300 of the editing terminal apparatus 30 for example and displays a layout of display data to be printed in this print layout adjusting window 304. It should be noted that the creation and display of the print layout adjusting window 304 may be executed automatically by the print layout adjusting section 149 upon completion of the extraction of the above-mentioned display data or only upon a request from the staff.

Browsing the layout in the print layout adjusting window 304, the staff can adjust the positional relationship between display data, adjust font of each display data, adjust colors, draw ruled lines, and execute other print layout adjusting operations. It should be noted that this print layout adjustment processing may be automatically executed by the print layout adjusting section 149 on the basis of preset basic layout patterns.

The display data adjusted in print layout as described above are stored in the storage unit 112 for example and outputted to the print control unit 132 when the print start conditions are satisfied for example.

Now, each of the components of the metadata processing unit 140 has been described. It is obvious that the metadata processing unit 140 may not always be arranged in the recording/reproducing apparatus 100; instead, the metadata processing unit 140 may be arranged in the editing terminal apparatus 30.

The above-mentioned metadata processing unit 140 may also be configured as a dedicated apparatus (hardware) for example as long as it can realize the above-mentioned processing capabilities or may be configured by installing application programs for executing the above-mentioned processing onto the recording/reproducing apparatus 100 or the editing terminal apparatus 30. In the latter case, the application programs may be provided for the recording/reproducing apparatus 100 or the editing terminal apparatus 30 by recording media such as CD-ROM or may be stored in the storage unit 112 in advance or in peripheral equipment connected to the communication interface 113, for example.

The above-mentioned processing by the metadata processing unit 140 allows the printer 130 to print necessary metadata on the metadata display sheet 66 in a suitable layout.

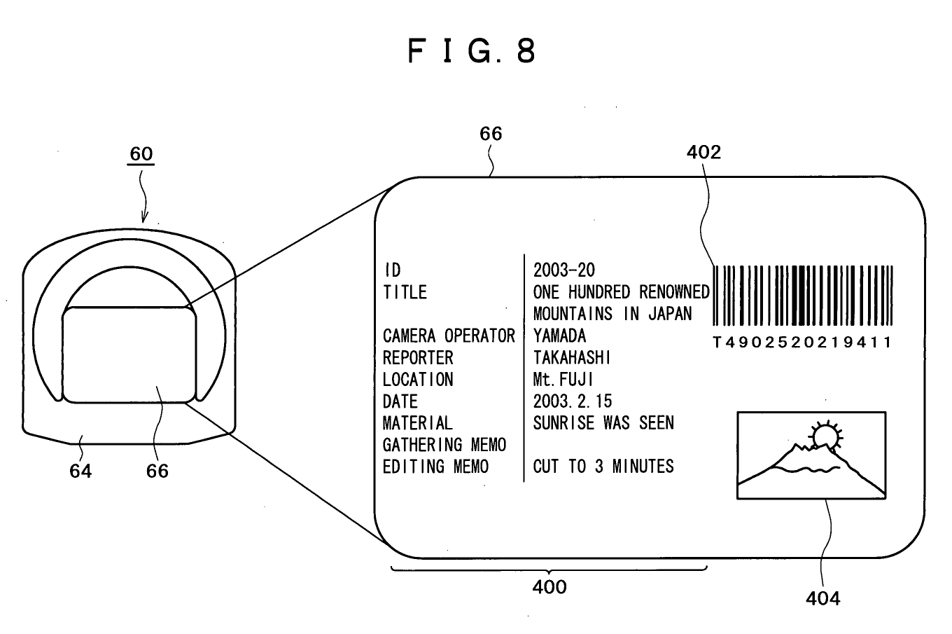

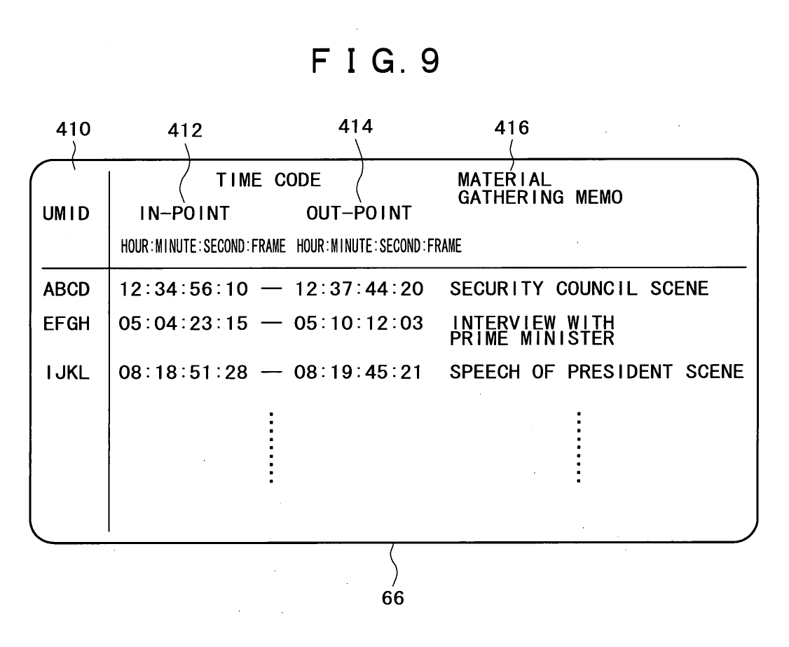

The following describes display modes of the metadata (namely, display data) printed on the metadata display sheet 66 by the printer 130 with reference to FIGS. 8 and 9. FIGS. 8 and 9 illustrate examples in which the metadata printed on the metadata display sheet 66 by the printer 130 according to the present embodiment are displayed.

First, in the example shown in FIG. 8, metadata 400 which are text, a bard code 402, and a thumbnail image 404 are displayed on the metadata display sheet 66 attached to the optical disk 60.

The text-based metadata 400 include “ID: 2003-20”, “Title: One Hundred Renowned Mountains of Japan”, “Camera Operator: Yamada”, and so on, for example. By displaying metadata in text, the staff who take care of the optical disk 60 can easily and clearly understand the content information about the optical disk 60. Consequently, the optical disk 60 in which desired content data are recorded can be easily and quickly found from among a plurality of optical disks 60. In addition, because the text-based metadata 400 are automatically displayed by the printer 130, the staff taking care of the optical disk 60 need not hand-write the metadata otherwise practiced conventionally, thereby enhancing convenience and accuracy in the display of metadata.

The barcode 402 is obtained by bar-coding the content identification metadata for example. Displaying metadata in barcode allows the quick and correct reading of the barcode 402 displayed on the metadata display sheet 66, by use of a barcode reader for example. By mechanically reading the barcode 402 from the metadata display sheet 66 and interpreting the information recorded to the barcode, the content and storage location thereof for example can be identified for sure. This allows the staff taking care of the optical disk 60 to perform search, editing, and managing operations in a more reliable manner. In addition, this also allows the quick reading, from the optical disk 60, of the other metadata associated with video content data identified by the barcode 402 which are not displayed as the text-based metadata 400.

The thumbnail image 404 typically represents the video content recorded to the optical disk 60. Displaying the thumbnail image 404 on the metadata display sheet 66 visually appeals the content information of the optical disk 60 to the staff taking care thereof. Consequently, the staff taking care of the optical disk 60 can easily and quickly understand the contents of the video content data recording to the optical disk 60 at a glance of the thumbnail image 404.

In the example shown in FIG. 9, time codes representative of “UMID” 410, “In-Point” 412, “Out-Point” 414 and metadata “Material Gathering Memo” 416, for example, are displayed in text on the metadata display sheet 66 attached to the optical disk 60.

The above-mentioned display is made when the video content data of a plurality of takes after the rough editing are recorded to the optical disk 60. For example, for the video content data of a take with “UMID” 410 being “ABCD”, a range extracted by the rough editing is from “12:34:56:10” of “In-Point” 412 to “12:37:44:20” of “Out-Point” 414. When “Material Gathering Memo” 416 is referenced, the video content data of this take is found to be the contents about “Security Council Meeting Scene”.

Thus, by displaying the metadata about the video content data after the rough editing onto the metadata display sheet 66 in the form of a list, the staff taking care of the optical disk 60 can accurately understand the number, sequence, length of time, and contents for example of the video content data recorded to the optical disk 60.

(4) Metadata Display Method

The following describes a metadata display method by use of the optical disk 60 and the recording/reproducing apparatus 100 having the above-mentioned configurations. In what follows, two examples of display methods will be described: in one example, the recording/reproducing apparatus 100 automatically displays metadata onto the surface of the optical disk 60 and in the other, the recording/reproducing apparatus 100 semi-automatically displays metadata onto the surface of the optical disk 60 as instructed by the staff taking care of the optical disk 60.

(4-1) Method of Automatically Displaying Metadata

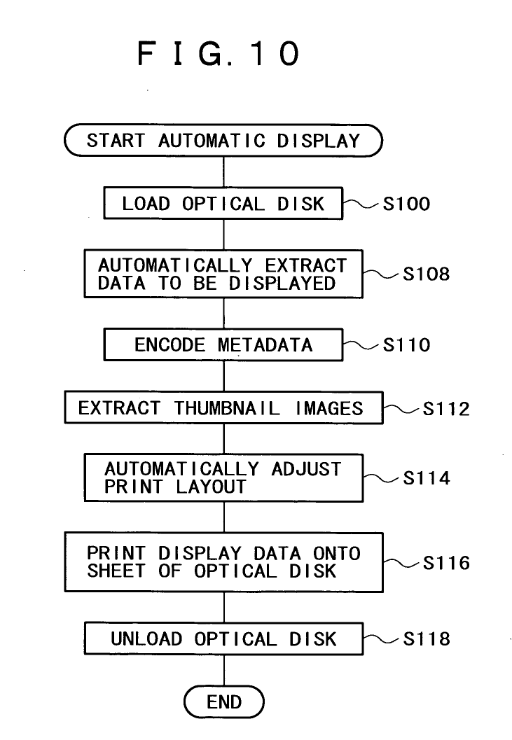

First, a method of automatically displaying metadata onto the surface of optical disk 60 by use of the recording/reproducing apparatus 100 will be described with reference to FIG. 10. FIG. 10 is a flowchart describing a metadata automatically displaying method according to the present embodiment.

As shown in FIG. 10, the optical disk 60 is loaded on the recording/reproducing apparatus 100 in step S100.

Next, in step S108, the display data to be displayed on the metadata display sheet 66 are automatically extracted from the metadata stored in the optical disk 60. The metadata extracting section 142 of the recording/reproducing apparatus 100 searches the loaded optical disk 60 for metadata and their type by use of the recording/reproducing unit 120. Next, the metadata extracting section 142 extracts the display data from the detected metadata under preset extraction conditions. These conditions include one that only the metadata of particular types (for example, the metadata associated with “ID”, “Title”, “Camera operator”, “Location”, Material gathering memo”, and “Thumbnail image position”) are to be always extracted. These extraction conditions preset by the staff allow the metadata extracting section 142 to automatically execute the extraction of the display data when the optical disk 60 has been load for example.

In step S110, at least a part of the extracted display data is coded. If the coding processing has been turned on by the staff and the preset display data (“UMID”, “Material gathering ID”, and so on) to be coded are found in the extracted display data, then the metadata coding section 144 automatically converts the display data concerned into a barcode form for example.

Next, in step S112, thumbnail image data are extracted. If the metadata associated with “Thumbnail image position” has been extracted in step S108, the thumbnail image extracting section 148 automatically extracts the thumbnail image data from the corresponding content data as the display data on the basis of the time code information indicated by the metadata concerned for example.

In step S114, the print layout of the display data are automatically adjusted in layout. The print layout adjusting section 149 automatically adjusts the layout of the display data extracted in step S144 and step S148, in the layout of which these display data are printed on the metadata display sheet 66. At this moment, the print layout adjusting section 149 selects a suitable layout pattern according to the type and number of the extracted metadata from among the layout patterns preset by the staff for example. On the basis of the extracted layout pattern, the print layout adjusting section 149 can automatically perform the above-mentioned layout adjustment.

In step S116, the display data are printed on the metadata display sheet 66 attached to the optical disk 60. On the basis of the print layout adjusted as described above, the printer 130 prints the extracted display data onto the metadata display sheet 66. Consequently, the necessary metadata are suitably displayed on the metadata display sheet 66 as shown in FIG. 7.

Next, in step S118, the optical disk 60 is unloaded from the recording/reproducing apparatus 100. As a result, a part or all of the metadata recorded to the optical disk 60 are suitably displayed on the surface of the optical disk 60 unloaded from the recording/reproducing apparatus 100. Therefore, by visually checking the displayed metadata, the staff can easily and correctly understand the contents of the video content data recorded in this optical disk 60.

Thus, the above-mentioned metadata automatically displaying method automatically displays the metadata recorded to the optical disk 60 onto the surface of thereof by merely loading the optical disk 60 on the recording/reproducing apparatus 100.

(4-2) Method of Semi-Automatically Displaying Metadata

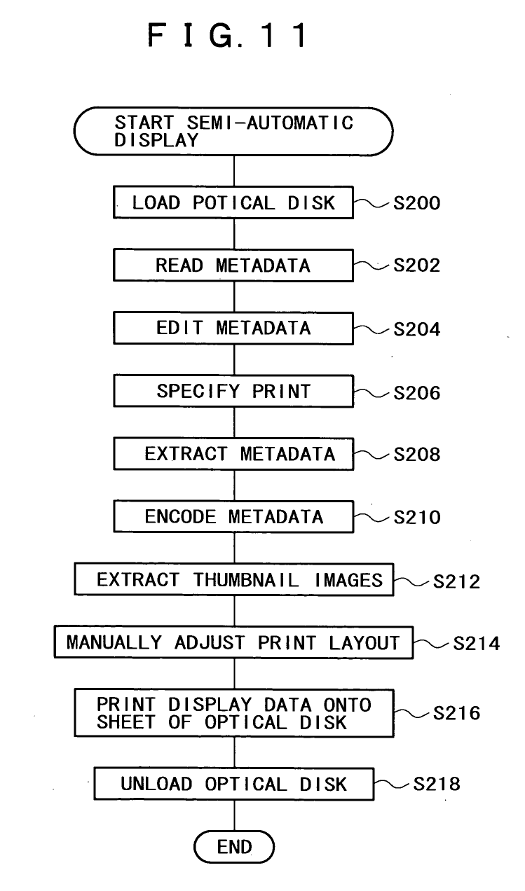

The following describes a method of semi-automatically displaying metadata onto the surface of the optical disk 60 by use of the recording/reproducing apparatus 100 with reference to FIG. 11. FIG. 11 is a flowchart describing the metadata semi-automatically displaying method according to the present embodiment.

As shown in FIG. 11, the optical disk 60 is loaded on the recording/reproducing apparatus 100 in step S200.

In step S202, the metadata are read from the optical disk 60. For example, the metadata extracting section 142 searches the loaded optical disk 60 for the metadata and the type thereof by use of the recording/reproducing unit 120. Next, the metadata for use in editing processing by the editing terminal apparatus 30 are read as required from the detected metadata.

In step S204, the metadata are edited. In accordance with the contents of the editing of video content data, the metadata editing section 146 newly creates the metadata associated with the video content data concerned or updates the existing metadata. Thus, the metadata editing section 146 can edit the metadata for example read from the optical disk 60. It should be noted that this step is not essential.

Next, in step S206, a print instruction is given by user. Through the operator unit 106 of the recording/reproducing apparatus 100 or the operator unit of the editing terminal apparatus 30, the user gives an instruction for printing the metadata recorded to the optical disk 60 and/or the metadata edited in step S204 to the metadata display sheet 66 attached to the optical disk 60, for example. The recording/reproducing apparatus 100 starts displaying the metadata only upon reception of this instruction, for example. In this point, the present operation flow differs from that of the above-mentioned metadata automatically displaying method (in which the display processing automatically starts upon loading of the optical disk 60 for example).

In step S208, the display data to be displayed on the metadata display sheet 66 are manually extracted from the metadata stored in the optical disk 60 and/or the metadata (selectable metadata) edited in step S204. In this step, the manual extraction processing as described with reference to FIG. 6 is executed. In this manual extraction processing, the staff selects the metadata to be displayed from the above-mentioned selectable metadata and the metadata extracting section 142 extracts the display data on the basis of this selection. This manual extraction processing allows the staff to select the metadata to be displayed on the optical disk 60 as desired.

In step S210, at least a part of the extracted display data is coded. This step is substantially the same as step S110 described with reference to FIG. 10 and therefore its further description will be skipped.

Next, in step S212, thumbnail image data are extracted. This step is substantially the same as step S112 described with reference to FIG. 10 and thereby its further description will be skipped.

In step S214, the print layout of the display data is manually adjusted. In this step, the processing of manually adjusting print layout as described with reference to FIG. 7 is executed. In this manual print layout adjustment processing, the staff executes the adjustment of the positional relation between display data, the adjustment of the font of each display data, and adjustment of color and ruled line, for example, in a desired manner while browsing the print layout adjusting window 304. On the basis of the adjustments made by the staff, the print layout adjusting section 149 outputs the display data adjusted in layout to the storage unit 112 for example. This manual print layout adjustment processing allows the staff to adjust the metadata to be displayed on the optical disk 60, in a desired manner.

In step S216, the display data are printed on the metadata display sheet 66 attached to the optical disk 60. This step is substantially the same as step S116 described with reference to FIG. 10 and therefore its further description will be skipped.

Next, in step S218, the optical disk 60 is unloaded from the recording/reproducing apparatus 100. This step is substantially the same as step S118 described with reference to FIG. 10 and therefore its further description will be skipped.

Thus, the metadata semi-automatic display method allows the semi-automatic display on the optical disk 60 of only the metadata selected by the staff, recorded to the optical disk 60, in a desired layout.

(5) Variations

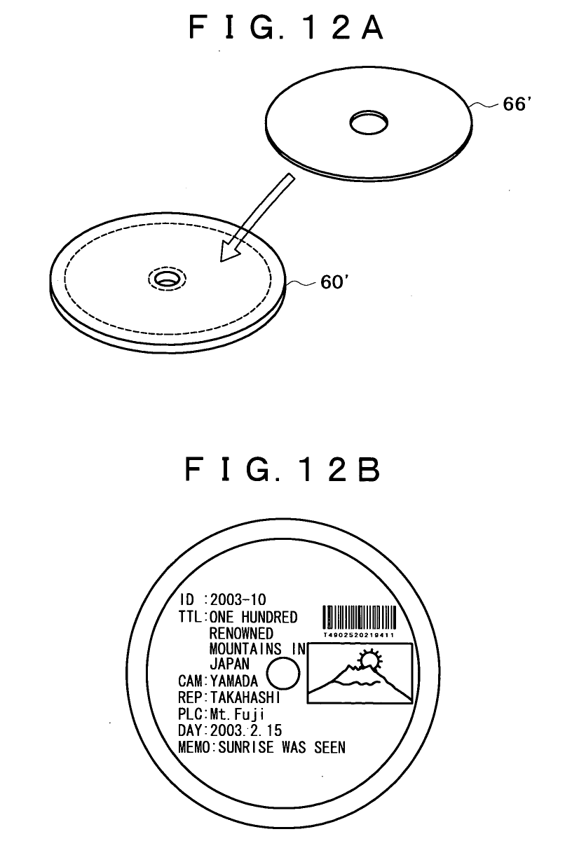

The following describes some variations of the optical disk 60 according to the present embodiment with reference to FIGS. 12A and 12B. FIGS. 12A and 12B illustrate an optical disk 60′ according to a variation of the present embodiment.

In the description made above, an example of the optical disk 60 with cartridge is used as the recording medium associated with the present embodiment. However, the configuration of the optical disk 60 is not restricted thereto. For example, the optical disk 60′ without a cartridge is as applicable as the optical disk 60.

The optical disk 60′ has its disk body without a cartridge; currently, this type of optical disk often finds its application in the CD-RW and the DVD-RW for example. In order to display metadata on the optical disk 60′, an approximately doughnut-shaped metadata display sheet 66′ may be directly attached to the non-recording side of the optical disk 60′ as shown in FIG. 12A.

This configuration allows the recording/reproducing apparatus 100 to extract display data from the metadata recorded to the optical disk 60′ and print the extracted display data onto the metadata display sheet 66′. As a result, text-based metadata, a thumbnail image, a barcode, and so on are shown on the metadata display sheet 66′ in a manner suitable for the circular shape of the optical disk 60′ as shown in FIG. 12B.

As described above, according to the optical disk 60, recording/reproducing apparatus 100, and metadata display method associated with the above-mentioned first embodiment of the invention, desired metadata are extracted from the optical disk 60 in which video content data and their metadata are recorded and the extracted metadata are printed on the metadata display sheet 66 attached to the optical disk 60. Consequently, the contents of the metadata recorded to the optical disk 60 are directly shown on the surface of the optical disk 60 as the information that the staff can easily and clearly understand at a glance. Hence, the metadata display method according to the first embodiment allows the user to correctly understand the information about content only by visually checking the recording media from the outside, unlike related-art methods in which only a barcode or an IC memory is installed on recording media. In addition, since a thumbnail image can be shown on the metadata display sheet 66, the user can more easily understand the contents of the video content data recorded to the optical disk 60. This setup allow the staff to quickly and easily identify and search the optical disk 60.

Since metadata can be shown on the optical disk 60 automatically or semi-automatically by use of the recording/reproducing apparatus 100, the job of displaying metadata can be significantly speeded up and facilitated. This leads to a significant reduction in labor and time which are otherwise much required in conventionally practiced hand-written labeling and manual input in database, thereby saving labor and enhancing efficiency in a metadata displaying operation. In addition, the novel configuration can prevent writing mistakes when manually writing labels and input errors when manually entering data into a database as described above, thereby ensuring the correctness of metadata.

Further, the novel configuration can manage the metadata associated with video content data only on the optical disk 60 in a centralized manner, unlike related art where metadata are managed in two databases of handwritten or printed labels and barcodes and IC memories. Therefore, the novel configuration provides the efficient, correct, and easy management of metadata.

Since the metadata display sheet 66 may be rewritten more than several hundred times, there is no need for repeating attachment and detachment of labels every time metadata are updated, unlike the related art. Also, since coded data such as barcodes can be displayed on the metadata display sheet 66, the optical disk 60 and its contents can be mechanically identified and specified.

Consequently, the ease of operation and the efficiency of management of recording media such as the optical disk 60 are significantly enhanced.

While the preferred embodiments of the present invention have been described using specific terms, such description is for illustrative purposes only, and it is to be understood that changes and variations may be made without departing from the spirit or scope of the appended claims.

For example, the recording medium according to the above-mentioned embodiments is constituted by the optical disk 60; however, the present invention is not restricted thereto. The recording medium may be any other media that can be accessed for reading/writing by various types of information processing apparatuses; for example, magnetic recording media such as a hard disk, a flexible disk, a magnetic tape (such as a video tape), a magnetic disk, and a magnetic card, a memory card such as Compact Flash, Smart Media, SD memory card, Memory Stick, MMC, and xD Picture Card (all trademarks), a magneto-optical disk such as an MO and an IC card, photographic films, and various RAMs and ROMs such as flash memory.

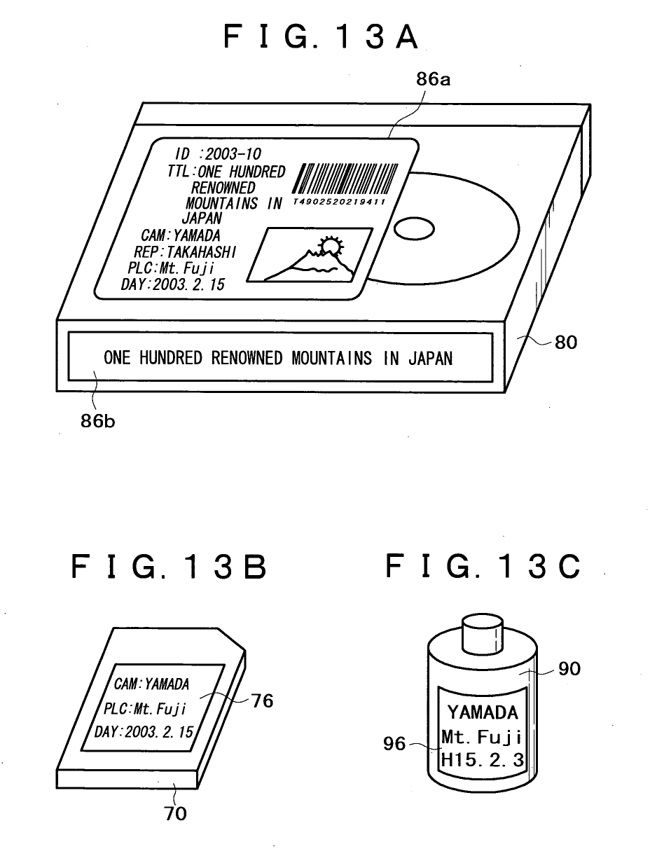

The following describes a video tape 80, a memory card 70, and a photographic film 90 as variations of the storage media with reference to FIGS. 13A, 13B and 13C.

As shown in FIG. 13A, a comparatively large metadata display sheet 86a is attached on the top side of the cartridge of the video tape 90 and a comparatively small metadata display sheet 86b is attached on the back side of the cartridge. The metadata display sheet 86a shows various text-based metadata, a barcode, and a thumbnail image as described with reference to FIG. 8. By browsing the metadata display sheet 86a, the user can recognize in detail the content information of the video content data recorded to the video tape 90. On the other hand, only text “One Hundred Renowned Mountain of Japan” which is the title of the video content data is shown on the metadata display sheet 86b. Consequently, when a plurality of video tapes 90 are arranged on shelves for example, the titles printed on the metadata display sheets 86b face the user, thereby allowing him to easily locate desired video tapes 90.

As shown in FIG. 13B, a metadata display sheet 76 is attached on the cartridge of the memory card 70. The memory card 70 stores not only the above-mentioned video content data, but also the other kinds of content data that can be generally handled by computers, such as audio content data, digital camera's still picture data, various document content data, and graphics content data. In the example shown in FIG. 13B, the memory card 70 stores the still image data taken by a digital camera and its metadata display sheet 76 shows the camera operator who took the digital pictures stored in the memory card and the location and date of picture taking. Consequently, the user of the digital camera can easily recognize what kind of still picture data taken by the digital camera are stored in this memory card.

As shown in FIG. 13C, a metadata display sheet 96 is attached around the outside of the cartridge of the photographic film 90. The content data recorded to this photographic film 90 are still picture data for example. With the photographic film 90, various kinds of metadata (date of shooting date, shooting condition, camera operator, and shooting location, for example) associated with the still picture data can be recorded to an area not recorded with still picture data on the film medium accommodated inside, for example. Consequently, the metadata display sheet 96 showing the metadata recorded to the film medium allows the user to easily recognize the contents of the still picture data recorded to the photographic film 90.

The information processing apparatus according to the above-mentioned embodiments is configured as the recording/reproducing apparatus 100 of the editing terminal apparatus 30; however, the present invention is not restricted thereto. The information processing apparatus according to the above-mentioned embodiments may be any one of the information processing apparatuses that can handle the above-mentioned various kinds of recording media; for example, any of personal computers illustrated by the planning terminal apparatus 10, the field PC 50, or the editing terminal apparatus 30 for example; any of various imaging apparatuses such as a video camera like a camcorder illustrated by the imaging apparatus 40, a digital still camera, and an analog still camera, any of disk units (including DVD player, CD player, MD player, tape recorder, IC recorder, and hard disk drive for example) of various recording/reproducing apparatuses, recording-only apparatuses, and reproduction-only apparatuses such as the recording/reproducing apparatus 12 of the planning terminal apparatus 10; any of various broadcasting equipment such as a VTR; any of mobile communication terminals such as a PDA and a mobile phone; any of receiving terminals such as television set, radio set, a tuner, and a decoder; any of various home information electronics; and any of printer, facsimile machine, and plain telephone. The content data include not only video content data, but also any content data that can be handled by the above-mentioned information processing apparatuses.

The following describes an example in which the imaging apparatus 40 has both the printer 130 and the metadata processing unit 140. As the taken video content data are processed, the imaging apparatus 40 generates the above-mentioned various metadata and records the generated metadata to recording media such as the optical disk 60 by relating the metadata with the video content data. In this state, the imaging apparatus 40 may have the metadata processing unit 140 function to read the metadata recorded by the imaging apparatus 40 from the optical disk 60 again to extract display data and print and display the extracted display data onto the metadata display sheet 66 of the optical disk 60, for example. This setup allows the imaging apparatus 40 to automatically show the metadata recorded to storage medium such as the optical disk 60 for example onto the surface of the storage medium.

With the above-mentioned embodiments, an example is used in which the recording/reproducing apparatus 100 is one of the component of the video program production assistance system 1; however, the present invention is not restricted thereto. For example, the information processing apparatus may alternatively be used as a standalone unit rather than one of the components of the system.

The metadata display sheet 66 according to the above-mentioned embodiments is made of a thermo rewrite sheet; however, the present invention is not restricted thereto. For example, the metadata display sheet 66 may be made of any other rewrite sheets, a magnetic rewrite sheet with microscopic capsules filled with colored magnetic powder for example, as long as they are rewritable.

In the above-mentioned embodiments, the information display area is formed by attaching the metadata display sheet 66 on the surface of each storage media (the optical disk 60); however the present invention is not restricted thereto. For example, the information display area may be formed by integrally forming the metadata display sheet 66 and the cartridge or the disk body itself of each storage medium such as the optical disk 60 into one unit. Also, for the information display area, any display means or display media may be used as long as they can display extracted metadata.

In the above-mentioned embodiments, the information display unit is constituted by the printer 130; however, the present invention is not restricted thereto. For example, the information display unit may be any other writing means as long as they can show the above-mentioned display data into the above-mentioned display area.

As described and according to the invention, the metadata associated with content data recorded to storage media can be directly and easily displayed on the storage media in a visually recognizable manner. In addition, the displayed metadata can easily updated. Therefore, the novel configuration allows the efficient management of storage media as well as the content information stored therein.

What is claimed is:

1. An information processing apparatus for handling a storage medium storing content data and metadata associated therewith, said storage medium being provided with on a surface thereof an information display area, comprising:
an extracting section for extracting, from said metadata stored on said storage medium, display data to be displayed in said information display area; and
an information display unit for displaying the extracted display data onto said information display area.

2. The information processing apparatus according to claim 1, wherein said information display area is rewritable.

3. The information processing apparatus according to claim 1, wherein said information display area is exchangeable with another information display area.

4. The information processing apparatus according to claim 2, wherein said information display area is constituted by a rewrite sheet.

5. The information processing apparatus according to claim 1, wherein said information display unit displays, in said information display area, said display data by coding at least a part thereof.

6. The information processing apparatus according to claim 1, further comprising:
a metadata editing section for editing said metadata in accordance with a processing result of said content data,
wherein said extracting section extracts said display data also from the edited metadata.

7. The information processing apparatus according to claim 1, wherein said content data include at least video content data and said information display unit displays, in said information display area, thumbnail image data extracted from said video content data on the basis of said metadata.

8. A storage medium which is accessed for reading and writing by an information processing apparatus, stores at least content data and metadata associated therewith, and is formed with an information display area on a surface thereof,
wherein display data extracted from said metadata is displayed in said information display area by said information processing apparatus.

9. The storage medium according to claim 8, wherein said information display area is rewritable.

10. The storage medium according to claim 8, wherein said information display area is exchangeable with another information display area.

11. The storage medium according to claim 9, wherein said information display area is constituted by a rewrite sheet.

12. A metadata display method for displaying metadata on a surface of a storage medium storing said content data and metadata associated therewith, said storage medium being provided with on the surface thereof an information display area, comprising the steps of:
extracting, by said information apparatus handling said storage medium, from said metadata stored on said storage medium, display data to be displayed in said information display area; and
displaying the extracted display data onto said information display area.

13. The metadata display method according to claim 12, wherein said information display area is rewritable.

14. The metadata display method according to claim 12, wherein said information display area is exchangeable with another information display area.

15. The information display method according to claim 13, wherein said information display area is constituted by a rewrite sheet.

16. The metadata display method according to claim 12, wherein at least a part of said extracted display data is coded to be displayed in said information display area.

17. The metadata display method according to claim 12, wherein said display data are extracted also from the metadata edited by said information processing apparatus.

18. The metadata display method according to claim 12, wherein said content data include at least video content data and
thumbnail image data extracted from said video content data on the basis of said metadata are displayed in said information display area.
